(19) United States
(12) Patent Application Publication
(10) Pub. No.: US 2025/0264633 A1
(43) Pub. Date: Aug. 21, 2025

(54) METHOD TO GENERATE A WATER SATURATION MODEL WITH CAPILLARY PRESSURE UNCERTAINTIES AND ITS USE

(71) Applicant: PETRÓLEO BRASILEIRO S.A. - PETROBRAS, Rio de Janeiro (BR)

(72) Inventor: LUCIANO DOS SANTOS MARTINS, Rio de Janeiro (BR)

(73) Assignee: PETRÓLEO BRASILEIRO S.A. - PETROBRAS, Rio de Janeiro (BR)

(21) Appl. No.: 19/052,972

(22) Filed: Feb. 13, 2025

(30) Foreign Application Priority Data
Feb. 16, 2024 (BR) 1020240031059

(51) Int. Cl. G01V 20/00

(52) U.S. Cl. CPC G01V 20/00

(57) ABSTRACT

The present invention describes a method to generate a water saturation model with uncertainties from capillary pressure data. This method has application in wells, for the determination of possible regions of mobile water within a hydrocarbon zone, and at the reservoir scale, for the generation of a water saturation model that takes into account possible uncertainties in relation to capillary pressure curves.

### CROSS-REFERENCES TO RELATED APPLICATIONS

This application claims the benefit of priority to Brazilian Patent No. BR 1020240031059 filed Feb. 16, 2024, the contents of which are hereby incorporated by reference in their entirety for all purposes.

### FIELD OF THE INVENTION

The present invention belongs to the field of petrophysical analysis. More specifically, the present invention refers to a method to generate a saturation model with uncertainties from capillary pressure data useful in determining the existence or non-existence of a transition zone.

### BACKGROUND OF THE ART

Oil and gas exploration is a complex and highly specialized undertaking. In this scenario, the existence or not of a transition zone is important for both exploration and production, and understanding the existence of transition zones in rocks is necessary to obtain information about the geological composition and identify promising reservoirs.

Often, water saturation models are used to understand and predict how water, oil, and gas are distributed within a rock formation. Water saturation refers to the fraction of the volume of the pores of a reservoir rock that is occupied by water. This calculation is crucial in oil and gas exploration and production, as it provides information about the amount of porous space that is filled with water, as opposed to hydrocarbons that can be produced.

The most common method for calculating water saturation is the Archie's Model, developed by geophysicist Gus Archie. This model relates the electrical resistivity of the rock with the porosity and saturation of water. To apply the Archie's Model, data obtained through well profiles, such as rock porosity and electrical resistivity, are required. Once the data is collected, Archie's equation is used to calculate water saturation at different depths of the well. Water saturation is critical for determining the volume of water relative to the volume of hydrocarbons in a reservoir. This directly affects production decisions, as higher water saturation can reduce the amount of recoverable oil or gas.

Another alternative for calculating water saturation is the use of a saturation model from the free water level or Saturation height (SwHt). For this, capillary pressure data is required, information obtained from laboratory tests with rock through mercury injection, centrifuge, or membrane.

However, since the generation of a water saturation model comprises the analysis of samples taken from the well, and these tests are performed under laboratory conditions, a conversion to the rock-fluid system of the reservoir is necessary, mainly due to the uncertainty in the measurements and the variability in the rock formations. These conversion parameters are typically not measured and are difficult to estimate.

Thus, the present invention proposes a solution to this technical problem by describing a method to generate a water saturation model by capillary pressure through uncertainty analysis in the input parameters of the processing.

In the state of the art, other methods and systems are described to take into account uncertainties in profile measurements and petrophysical parameters. Initially, the patent U.S. Pat. No. 8,311,789 B2 stands out, which describes a system and method to perform Monte Carlo simulations on well logging data. The patent deals with an uncertainty analysis using the Monte Carlo method in the calculations of water saturation (Sw) and permeability (K) for the classification of zones according to the type of fluid and productivity in a well.

The present invention, by its turn, describes a model of Sw with uncertainties generated from capillary pressure data. Its application in a well would be for the determination of possible regions of mobile water (water saturation greater than the irreducible with production potential) within a hydrocarbon zone, and at the reservoir scale, for the generation of a Sw model that takes into account possible uncertainties regarding the capillary pressure curves.

Although both inventions use the Monte Carlo technique for uncertainty analysis and rock data and profiles to determine water saturation, the present invention differs from the US patent in that i) it is not limited to the Monte Carlo technique, ii) it obtains a Sw model referring to the initial condition of the reservoir, even if it is already in a mature stage, iii) it indicates a potential region of mobile water within the hydrocarbon zone, iv) it uses porosity and permeability profiles as input data, v) it does not require calibration with formation testing, and vi) it determines regions to avoid for a potential perforation or which regions to test with a cable tool for assessing a potential mobile water region.

There is also patent U.S. Pat. No. 10,466,386 B2, which refers to a method for calculating water saturation (Sw) in low resistivity reservoirs. In it, two main techniques are used: the first using the Archie's model, weighting the final values obtained by microporosity; and the second using synthetic capillary pressure curves obtained from rock images, and zoning its reservoir using image profile. In the end, the two curves are compared for validation, and a more accurate calculation of the original volume in place in low resistivity reservoirs. The improvement occurs since low resistivity tends to underestimate the oil saturation calculated by conventional methods.

The aforementioned patent and the present invention are unique and completely similar in that they use the calculation of water saturation by capillary pressure. However, the US patent does not present a methodology to add uncertainty in relation to the capillary pressure curve for each facie zoned by the image profile, with the objective of obtaining a better volume of oil in place for low resistivity reservoirs. On the other hand, the objective of this invention is to indicate possible regions with mobile water and to generate a water saturation model by capillary pressure with uncertainties. In addition, the comparison between Archie's method and the capillary pressure in the referenced patent assumes that the reservoir is in its initial conditions.

The international application WO17003828A1 deals with a fit of the capillary pressure data through the hyperbolic tangent. The final water saturation model is obtained by combining the fitted model with petrophysical data. The patent application also suggests extrapolation to the reservoir scale, but without considering heterogeneities in relation to the capillary pressure curve. Again, the application also deals with the calculation of water saturation by capillary pressure. However, it is noteworthy that the present invention is not restricted to a fitting or interpolation method of laboratory data. In fact, the international application deals with a new fitting equation, but does not discuss how to consider the uncertainty regarding capillary pressure curves.

Another international application, WO13059585A4 uses a cross plot between functions of petrophysical properties (porosity, permeability, saturation etc.) to obtain the pore-elastic constant (g), wettability (sigma*cos (theta)) and the free water Level (FWL). The Monte Carlo method is used to seek a better fit of these parameters with respect to an objective function and not for an uncertainty analysis. It is mainly noteworthy that the present invention aims to determine possible regions with mobile water and a Sw model with uncertainties. The international application, however, does not discuss how to consider the uncertainties, especially regarding capillary pressure curves.

Finally, the BR 1120140325766 B1 patent estimates the water saturation of a reservoir using the resistivity obtained by the CSEM geophysical method to calculate water saturation, using Monte Carlo in a classical petrophysical model, such as, e.g., the Archie's equation. It should be noted that the petrophysical model is based on resistivity, while the present invention uses a petrophysical model based on capillary pressure. Even though both inventions calculate water saturation using a stochastic method, the ultimate goal of the patent is only a water saturation curve, so the present invention also seeks to estimate possible regions of mobile water.

Although the state of the art documents mentioned above present methodologies that use uncertainty analysis and the use of capillary pressure, none of them presents a methodology for obtaining a Sw curve with uncertainty using capillary pressure. The application WO17003828A1 suggests an extrapolation to the reservoir scale, but without taking into account the uncertainties. Moreover, the present invention is not limited to the Monte Carlo sampling techniques, the capillary pressure models or the fitting equations presented. Thus, it can be concluded that none of the documents presents the same objectives as the present invention, nor do they disclose a method for generating a water saturation model as described in the present invention, whether analyzed individually or in combination.

### BRIEF DESCRIPTION OF THE INVENTION

The present invention describes a method to generate a water saturation model from capillary pressure data, taking into account the uncertainties related to the process. The method comprises the following steps:
implement a random sampling technique on fluid parameters, profiles and capillary pressure data obtained from the laboratory, in which all data are associated with uncertainties;
convert the capillary pressure curve from the laboratory system to the reservoir and calculate the relationship between capillary pressure and height above the free water level (FWL);
calculate the water saturation by the height in relation to the FWL,
repeat the above steps until obtaining a water saturation curve in the initial conditions of the reservoir, in which the data is associated with uncertainties;
analyze the curve obtained above compared to the irreducible water saturation curve, in which the data may have less significant uncertainties; and
determine the possible regions with mobile water.

This method has application in wells, for the determination of possible regions of mobile water within a hydrocarbon zone, and at the reservoir scale, for the generation of a water saturation model that takes into account possible uncertainties in relation to capillary pressure curves.

### BRIEF DESCRIPTION OF FIGURES

To assist in the identification of the main characteristics of this invention and its results and technical effects, the referenced figures are presented as follows:

FIG. 1 presents a flowchart of the main steps of the method of the present invention, where (1) refers to the input of the input profiles, including porosity, permeability, and depth of the free water level (FWL), associated with uncertainty, (2) refers to the laboratory inputs, including interfacial tension data, contact angle, and fluid density, associated with uncertainty, (3) refers to the random sampling technique applied to the input data, including the capillary pressure curve and its uncertainties, taking into account its rock typing classification (rock class) in (4); then, (5) refers to the conversion of the capillary pressure curve from the laboratory system to the reservoir, (6) refers to the calculation of the relationship between capillary pressure and height above the free water level, with (7) being the calculation of water saturation by height in relation to the FWL. Also, (8) represents the water saturation curve in the initial conditions of the reservoir, associated with uncertainty, (9) represents the irreducible water saturation curve of the reservoir and (10) represents the analysis of the two curves of (8) and (9), leading to (11) which represents the determination of the possible regions with mobile water.

FIG. 2 shows the centrifuge tests grouped into a single rock class, with the capillary pressure already transformed into the reservoir system.

FIG. 3 presents the comparison between SwHt models with FWL of 3,210 m in track 5 (red) and Archie (blue shade) for three wells drilled in the same reservoir. The black dots on the same track represent the irreducible water saturation obtained in the laboratory from capillary pressure tests.

FIG. 4 presents the model comparison of SwHt with FWL at 3,240 m, Archie and irreducible water saturation rock data (black dots) for well 1.

FIG. 5 shows the variability of the SwHt and Swi curves for the parameter range in Table 1 for the three wells.

FIG. 6 shows the variability of the equivalent oil column in each well, considering the SwHt curve with uncertainties.

FIG. 7 presents the tornado chart showing the impact of each variable on the SwHt curve. The 3 wells were used for its construction.

### DETAILED DESCRIPTION OF THE INVENTION

Initially, it should be noted that the following description starts from the preferred embodiments of the invention, without being limited by them.

Unless otherwise defined, all technical and scientific terms used here have the same meaning as that generally understood by a person skilled in the art to which the present invention belongs.

The present invention refers to a method to generate a water saturation model from capillary pressure data, taking into account the uncertainties related to the process.

This method comprises the following steps:
implement a random sampling technique on fluid parameters, input profiles and capillary pressure data obtained from the laboratory, in which all data are associated with uncertainties;
convert the capillary pressure curve from the laboratory system to the reservoir and calculate the relationship between capillary pressure and height above the free water level (FWL);
calculate the water saturation by the height in relation to the FWL,
repeat the steps until obtaining the water saturation curve in the initial conditions of the reservoir, in which the data is associated with uncertainties;
analyze the curve obtained above compared to the irreducible water saturation curve with its due uncertainties; and
determine the possible regions with mobile water.

As described above, the method is capable of generating a water saturation model from capillary pressure data, information obtained from laboratory tests with rock through mercury injection, centrifuge or membrane. This data can also be estimated by correlation or from profile data.

The method of the present invention can perform different random sampling techniques, such as those selected from the Monte Carlo's method, Latin Hypercube (LHC), Stratified Sampling or any other that is capable of representing its distribution of uncertainties.

The parameters of rock-fluid interaction and fluids used in the method of this invention can be selected from interfacial tension data, contact angle and fluid density. The input profiles can be selected from porosity, permeability, and FWL depth data, or any other profile from which such properties are derived, such as density, neutron, magnetic resonance, sonic, pre-tests and resistivity, among others.

The irreducible water saturation curve data used for comparison can come from other profiles, laboratory, correlation or models.

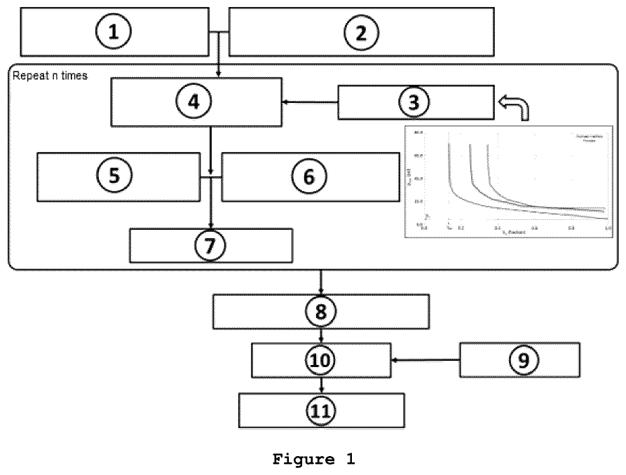

The sequence of main steps of the method of the present invention is presented in the flowchart of FIG. 1.

It is noted that steps 3-7 of FIG. 1 are repeated several times. This occurs in order to have as an output a water saturation curve in the initial reservoir conditions associated with uncertainty. The number of repetitions required may vary with the technique used and the level of uncertainty in each input variable at 1, 2, and 4. In theory, the greater the dimensionality of the problem, the greater the number of samples needed to have a more representative final result.

Next, the implementation of the method of this invention on a group of data is described, in order to illustrate its implementation and without the intention of unduly restricting or limiting its scope.

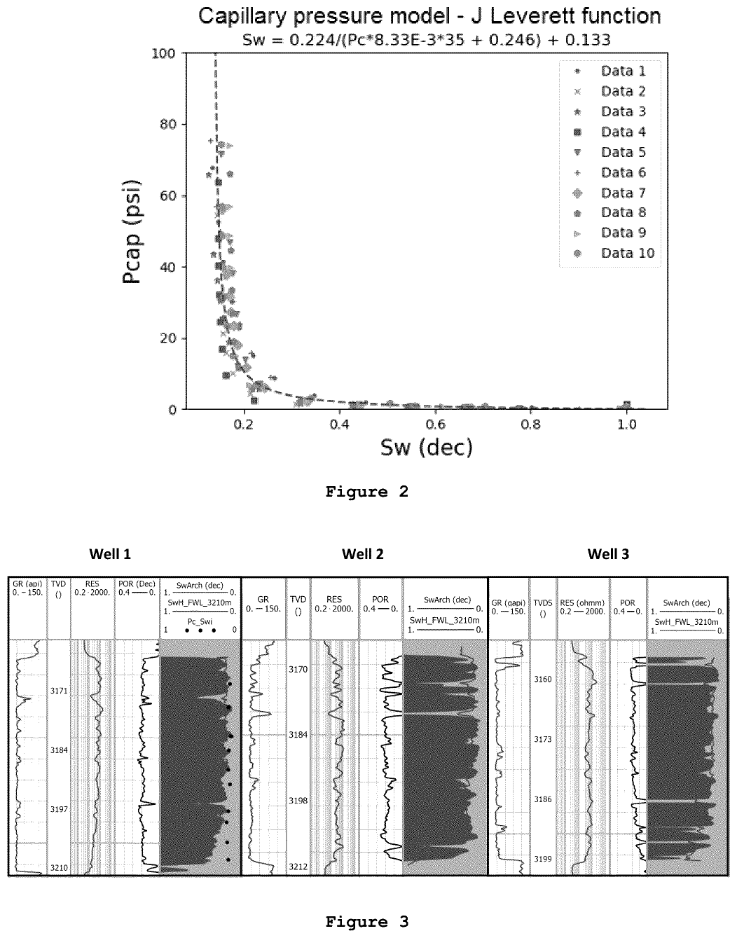

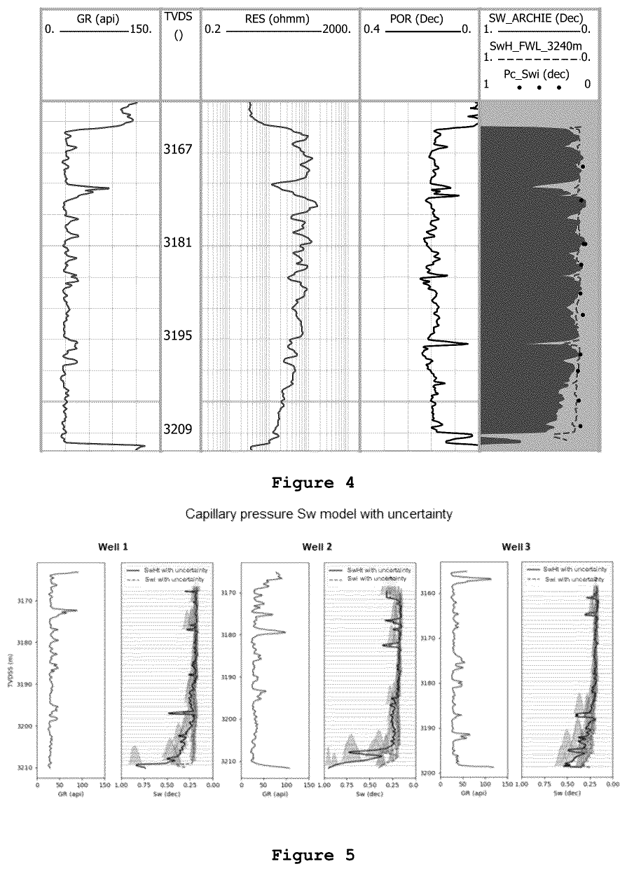

10 centrifuge tests were performed with the plug samples of an offshore well at the equivalent confinement pressure of the reservoir. These assays were divided into a single rock cluster (FIG. 2) and cover the entire reservoir, as can be seen in FIG. 4.

The adjustment model of the centrifuge tests applied to the reservoir was the hyperbolic J-Leverett, as it presents a faster asymptote to irreducible water saturation (Swi). The permeability and effective porosity curves used were those provided in [0033], with a FWL of 3,210 m and fluid density obtained from laboratory analyses (oil=0.57 g/cc and water=1.00 g/cc).

The reservoir studied is a water-wet sandstone, and the reservoir and laboratory rock and fluid parameters used are listed in table 1 below.

TABLE 1
Rock and fluid parameters used in the SwHt model

| | Laboratory | Reservoir |
|---|---|---|
| Contact angle | 30 | 30 |
| (degrees) | | |
| Interfacial tension | 48 | 30 |
| (dynes/cm) | | |

Next, the SwHt curves were compared with the Sw data obtained by Archie and the last saturation points of the capillary pressure data. These points do not necessarily represent the Swi value, but the minimum value obtained by the experiment. It can then be stated that a value of Swi less than or equal to those obtained by the centrifuge tests is expected. The results for the three wells are shown at the vertical depth in TVDSS (True Vertical Depth Sub Sea), in FIG. 3.

In general, there is a good fit between the saturation data obtained by different methods for wells. An important point is the reservoir base in FIG. 3. There is a good fit at the top between the saturation models, while at the bottom, the data from SwHt and Archie start to diverge from the rock data. This result indicates a possible mobile water/transition zone, as the Sw of the formation is greater than the Swi of the rock.

Wireline and tubing formation tests were conducted, but only at the top of the formation. An interesting result for the evaluation of the possible mobile water zone arises when comparing the results of SwHt for a deeper FWL (3,240 m) with Archie. If the reservoir is not at Swi, a difference in Sw values is expected, as can be seen in FIG. 4.

Next, the uncertainty analysis for the SwHt model was performed, since one way to evaluate the impact of each variable of a model on the final result is through an uncertainty analysis.

An analysis was performed in relation to the fluid parameters (interfacial tension and contact angle) that affect the SwHt curves. For this, a Monte Carlo simulation was performed to show the variability of the Sw values in relation to these parameters, and a tornado chart to illustrate which parameters have the greatest impact on this variability.

For the Monte Carlo (MC) analysis, uniform distributions were used with variability for each parameter presented in table 2. An uncertainty of 2m above and 2m below the FWL was also considered. The minimum number of iterations required to obtain a representative result with 5 variables and the variabilities presented is n=50,000 iterations.

TABLE 2
Variability of parameters for MC

| | Minimum | Maximum |
|---|---|---|
| Theta-Lab | 25 | 35 |
| Sigma-Lab (dyna/cm) | 43 | 53 |
| Theta-Res | 25 | 35 |
| Sigma-Res (dyna/cm) | 25 | 35 |

The results obtained by comparing SwHt for the two FWL scenarios (3,210 m and 3,240 m) are presented in FIG. 5 for each well. In this case, the SwHt curve referring to the deepest FWL would be equivalent to the Swi curve. The differences between the curves with uncertainties at the reservoir base indicate a transition zone with the potential to have mobile water.

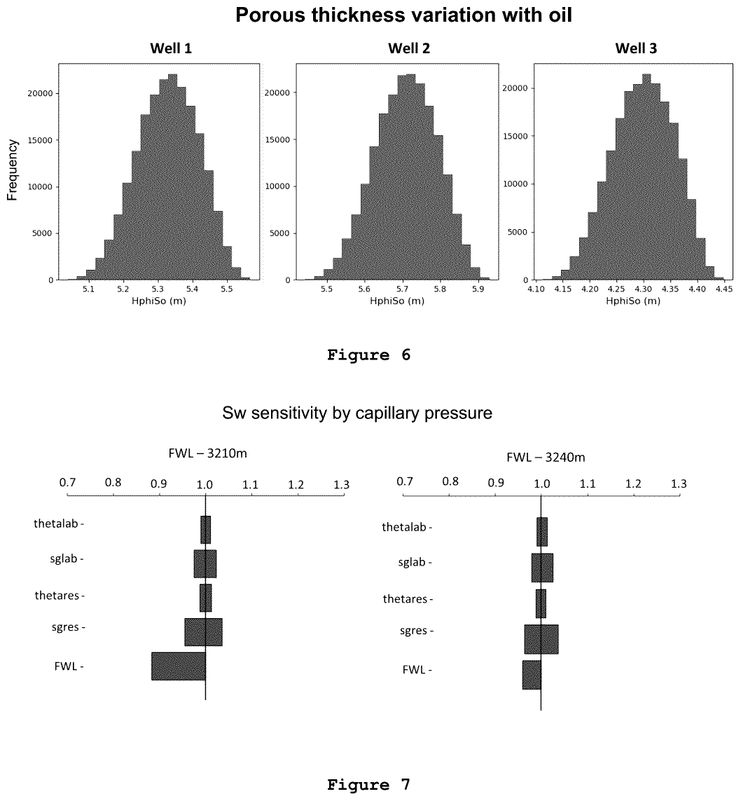

The variability of the porous thickness with oil (Hphiso) in relation to the distribution of SwHt (FWL=3,210 m) obtained in FIG. 5 is shown in FIG. 6. The cutoff parameters used were 50% for shale volume, 9% for effective porosity, and 50% for water saturation. The procedure for calculating volume in a 3D model of a reservoir with uncertainties would be similar to the one presented, and could be extrapolated by a person skilled in the art.

To understand which parameter has the greatest impact on the variation of the SwHt curves, a tornado chart was constructed. The base case was taken as the parameters in table 1. The variability of the Sw integral in relation to the base case was evaluated for the uncertainties in table 2, assuming a total variation of the FWL of 4 m. FIG. 7 presents the normalized results for the three wells together.

In FIG. 7, it is evident that the closer the reservoir is to the FWL, the greater its sensitivity to this parameter. The results of the uncertainty analyses, in the example presented, indicate that the fluid parameters (theta and sigma) have little effect on the curves of SwHt in relation to Hphiso and its variability.

Therefore, the implemented method was successful for the determination of possible regions of mobile water within a hydrocarbon zone (FIG. 5), and at the reservoir scale, for the generation of a water saturation model that takes into account possible uncertainties in relation to capillary pressure curves.

The skilled in the art will value the knowledge presented herein and can reproduce the invention in the presented embodiments and their variants, which are covered in the scope of the claims below.

1. A method to generate a water saturation model, comprising the following steps:
implement a random sampling technique on fluid parameters, input profiles and capillary pressure data obtained from the laboratory, in which all data are associated with uncertainties;
convert the capillary pressure curve from the laboratory system to the reservoir and calculate the relationship between capillary pressure and height above the free water level (FWL);
calculate the water saturation by the height in relation to the FWL,
repeat the steps until obtaining the water saturation curve in the initial conditions of the reservoir, in which the data is associated with uncertainties;
analyze the curve obtained above compared to the irreducible water saturation curve with its due uncertainties; and
determine the possible regions with mobile water.

2. A method, according to claim 1, wherein capillary pressure data is obtained from laboratory rock tests, such as mercury injection, centrifuge, or membrane, which can be estimated by correlation or from profile data.

3. A method, according to claim 1, wherein random sampling techniques can be by Monte Carlo method, Latin Hypercube (LHC), Stratified Sampling, or any other capable of representing its distribution of uncertainties.

4. A method, according to claim 1, wherein the fluid parameters used are selected from interfacial tension data, contact angle, fluid density and others.

5. A method, according to claim 1, wherein the input profiles are selected from porosity, permeability and FWL depth data, density, neutron, magnetic resonance, sonic, pre-tests, resistivity and, among others.

6. Use of the method, as defined in claim 1, for application in wells, for the determination of possible mobile water regions within a hydrocarbon zone, and at the reservoir scale, for the generation of a water saturation model that takes into account possible uncertainties regarding the capillary pressure curves.
